(19) United States
(12) Patent Application Publication
(10) Pub. No.: US 2015/0224440 A1
(43) Pub. Date: Aug. 13, 2015

(54) Method for scrubbing sulfur-containing gases with a circulated ammoniacal scrubbing solution

(71) Applicant: ThyssenKrupp Industrial Solutions AG, Essen (DE)

(72) Inventor: Holger Thielert, Dortmund (DE)

(21) Appl. No.: 14/424,881

(22) PCT Filed: Aug. 10, 2013
(86) PCT No.: PCT/EP2013/002409

§ 371 Date: Feb. 27, 2015

(30) Foreign Application Priority Data
Aug. 29, 2012 (DE) 10 2012 017 045.9

(51) Int. Cl. B01D 53/14

(52) U.S. Cl. CPC B01D 53/1493; B01D 53/1425; B01D 53/1406; B01D 53/1456; B01D 2252/10; B01D 2252/102; B01D 2252/20489; B01D 2252/204

(57) ABSTRACT

A method for scrubbing sulfur-containing gases with a circulated ammoniacal scrubbing solution is described. A sulfur-containing and nitrogen-containing gas is freed from sulfur compounds and nitrogen compounds with an aqueous alkaline solvent suchthat a purified industrial gas and a solvent loaded with nitrogen compounds and sulfur compounds is obtained, which is then passed into a desorption column. A desorbed acid gas is obtained which is passed into a Claus process such that the majority of the sulfur compounds are removed. The residual gas from the Claus process is hydrogenated such that a sulfur-containing and ammonia-containing residual gas is obtained which is passed into the absorption column where it is purified using the same aqueous solvent as in the first circuit, whereafter the loaded solvent is passed from this column into the desorption column from the first gas scrubber in such a manner that only one desorption column is required.

### CROSS-REFERENCE TO RELATED APPLICATIONS

This Application is the U.S. national phase of, and claims priority to, International Application No. PCT/EP2013/000249, filed Aug. 10, 2013, which designated the U.S. and which claims priority to German Patent Application No. DE 102012017045.9, filed Aug. 29, 2012. These applications are each incorporated by reference herein in their entireties.

### BACKGROUND OF THE INVENTION

1. Field of the Invention

The invention relates to a method for scrubbing sulfur-containing gases with a circulated ammoniacal scrubbing solution, in which a sulfur-containing and nitrogen-containing gas is freed from sulfur compounds and nitrogen compounds with an aqueous alkaline solvent in such a manner that a purified industrial gas and a solvent loaded with nitrogen compounds and sulfur compounds is obtained, which is then passed into a desorption column and thereupon a desorbed acid gas is obtained which is passed into a Claus process in such a manner that the majority of the sulfur compounds are removed, and the residual gas from the Claus process is hydrogenated in such a manner that a sulfur-containing and ammonia-containing residual gas is obtained which is again passed into an absorption column where it is purified using the same aqueous solvent as in the first circuit, and whereafter the loaded solvent is passed from this column into the desorption column from the first gas scrubber in such a manner that only one desorption column is required. In this manner, a single solvent may be used, since only one desorption column is required, and savings can be made in the system space requirement and expenditure on apparatus.

2. Description of the Related Art

When industrial processes are carried out, frequently industrial gases are obtained which are loaded with sulfur-containing acid gases, and therefore cannot be passed into the waste gas disposal. These acid gases are therefore removed from the industrial gas by a gas scrubber. In this case, a solvent loaded with sulfur-containing acid gases is produced, which is fed to a Claus process. The Claus process comprises, in broad outline, two reaction steps which serve for converting hydrogen sulfide into elemental sulfur. In the first step, a part of the sulfur-containing acid gases which consist of hydrogen sulfide (H₂S) and organosulfur compounds are burnt in a Claus furnace with an oxygenated gas. In this case, sulfur dioxide (SO₂) is obtained. The reaction proceeds according to the following reaction equation:

2H₂S+3O₂→2H₂O+2SO₂ (1).

In the second step, then, the remaining part of the sulfur-containing acid gases is reacted with the sulfur dioxide, wherein elemental sulfur is produced, the following reaction equation applying:

2H₂S+SO₂→2H₂O+⅜S₈ (2).

The sulfur can then be separated off from the remaining gas. The remaining desulfurized gas can be passed into the atmosphere or, since it still can contain remaining fractions of sulfur and further harmful gases, can be passed back into the gas scrubber which serves for scrubbing out the acid gas from the industrial gas.

EP1527013B1 teaches an exemplary Claus process. That patent document teaches a method for separating off hydrogen sulfide from coke oven gas with subsequent production of elemental sulfur in a Claus system, in which the hydrogen sulfide is removed from the coke oven gas by a regenerative scrubber-stripper system, and the concentrated acid gas is passed into a Claus unit which serves for converting the acid gas into elemental sulfur, wherein according to that invention the Claus unit is operated with only one Claus furnace and at a temperature of below 250° C., and the desulfurized Claus residual gas, after exit from the Claus unit, is recirculated to the gas scrubber. Owing to the recirculation of the desulfurized residual gas to the gas scrubber, no residual gas is passed into the atmosphere, which would be undesirable for environmental-protection reasons, since it still can contain remaining sulfur compounds and nitrogen compounds. At the same time, the expenditure on the system is reduced. The gas scrubber, however, for this method must be designed for an increased fraction of acid gases, since it must take up the recirculated desulfurized Claus residual gas.

In the gas scrubber, most of the nitrogen compounds present therein are also scrubbed out of the industrial gas. For certain applications it is necessary to recirculate in part or in full the nitrogen fraction in the industrial gas that is to be purified. Examples of such applications are the production of iron by the direct reduction method (“DRI” method) or certain further processing processes for synthesis gas. This has the consequence that the Claus residual gas cannot be recirculated to the industrial gas, since the former still contains a residual fraction of nitrogen compounds. For this reason, the exhaust gas of the Claus process is passed virtually exclusively into the atmosphere, and so it must be free from pollutants on introduction into the atmosphere. Finally, also, care must be taken that the Claus unit leaves only a small fraction of sulfur dioxide in the Claus residual gas, since otherwise sulfur dioxide accumulates in the absorbent solvent of the gas scrubber and, on account of the corrosive properties thereof, impairs the efficiency of the gas scrubber.

For industrial processes in which highly sulfur-containing and nitrogen-containing acid gases are produced, and their residual gases, after separating off the acid to gases and the final workup, are passed into the atmosphere, it is therefore advantageous, after carrying out the Claus process, to carry out a hydrogenation in which the sulfur dioxide and the remaining sulfur compounds in the Claus residual gas are hydrogenated. They are hydrogenated thereby to hydrogen sulfide (H₂S) which, after the recirculation to the gas scrubber, can again be recirculated to the Claus unit. In the hydrogenation, the remaining nitrogen compounds such as, for example, amines and nitrogen oxides, are also hydrogenated in such a manner that they are converted to ammonia (NH₃). The ammonia in turn can likewise be recirculated to the Claus process, where it is converted, after the recirculation, into nitrogen by combustion.

The nitrogen compounds and the ammonia can be removed from the process in this manner. EP0140573A1 teaches a method which feeds ammoniacal acid gases from an industrial process to a Claus process, and conducts the resultant Claus residual gas to a hydrogenation, and so the sulfur-containing and nitrogen-containing residual gases are hydrogenated to hydrogen sulfide and ammonia, and the gas obtained in the hydrogenation is subjected to a gas scrubber in such a manner that the hydrogen sulfide and the ammonia are scrubbed out, and the resultant loaded solvent is then fed to a desorption step and the desorbed gas obtained is recirculated to the Claus process for ammonia combustion. The purified gas obtained in the gas scrubber of the hydrogenated Claus residual gas is virtually nitrogen-free and is passed into a stoichiometric Claus unit for separating off the sulfur-containing compounds. However, the method requires a plurality of gas scrubbers proceeding from an industrial gas that is to be purified, as a result of which an increased expenditure on apparatus and an increased financial outlay owing to the differing solvent circuits are required.

If a highly sulfur-containing and nitrogen-containing acid gas is present, in an advantageous embodiment, an aqueous alkaline solvent may also be used. This is also far less sensitive to the sulfur dioxide which is present in the Claus residual gas after the Claus process.

GB1385432A describes a method for treating two different gas streams which contain hydrogen sulfide and sulfur dioxide, respectively, wherein the first gas stream is treated with an aqueous alkaline solvent in such a manner that the hydrogen sulfide is retained in the solvent, and the second gas stream is treated with an aqueous alkaline solvent which additionally contains a reducing sulfur compound, and the two loaded solvent streams are combined, wherein polysulfides precipitate out which can be removed from the process by decomposition to elemental sulfur in such a manner that a regenerated solvent is recovered. As aqueous alkaline solvent, for example, water is used which contains carbonates and hydroxides of ammonium, alkali metal ions or alkaline earth metal ions.

In practice it has become clear that the use of two different solvents, as described, is not necessary when a post hydrogenation is carried out in the conclusion to the Claus process, since the fraction of sulfur dioxide in the Claus residual gas is then relatively low, and addition of reducing sulfur compounds to the second solvent stream is not necessary. The acid gases can therefore be absorbed from the industrial gas using a solvent both in the first gas scrubbing step which serves for purifying the acid gas from the industrial process, and in the second gas scrubbing step which serves for purifying the Claus residual gas.

If in this case an aqueous alkaline solvent is used, the sulfur dioxide is sufficiently neutralized, whereas, for the nitrogen compounds and the hydrogen sulfide in the gases to be purified, in addition, a good dissolution capacity is present owing to the scrubbing solution in such a manner that also when only one solvent is used in the entire Claus process with hydrogenation, no losses in the absorption ability of the solvent are to be feared.

### SUMMARY OF THE INVENTION

The object is therefore to provide a method which purifies by a gas scrubbing process an industrial gas from industrial processes, said gas containing sulfur-containing and nitrogen-containing acid gases, desorbs the loaded solvent, conducts the resultant acid gas through a Claus process, hydrogenates the Claus residual gas obtained and conducts the hydrogenated Claus residual gas once more through a gas scrubber, wherein, for both gas scrubbers, a single solvent and a shared desorption column are used.

The invention achieves this object by a method through which an industrial gas from an industrial process is freed from acid gases by purification in a first gas scrubber and the resultant acid gas is desorbed and conducted into a Claus unit with subsequent hydrogenation, and the resultant hydrogenated Claus residual gas is passed into an absorption column in which the hydrogenated Claus residual gas is freed from acid gases by a renewed gas scrubbing process, as a result of which, likewise, a loaded solvent is obtained, and the loaded solvent obtained thereby is conducted into the same desorption column in which the loaded solvent from the first gas scrubber is desorbed.

By using a shared desorption column, one desorption column can be spared, which leads to a decrease of the system space requirement and the expenditure on apparatus, and, in addition, also, a unification of the system components for the gas scrubbing processes may be achieved, since in both gas scrubbing processes a shared solvent is used. As a result, a standardization and unification of the entire gas scrubbing process in a Claus system can be achieved, which in turn, leads to marked cost savings in the erection of the system and maintaining operations. As suitable industrial processes, for example, providing coke furnace gas or providing refinery gases come into consideration.

What is claimed, in particular, is a method for scrubbing sulfur-containing gases with a circulated aqueous alkaline solvent, wherein
a sulfur-containing and nitrogen-containing acid gas is scrubbed in a gas scrubber with an aqueous alkaline solvent in such a manner that the sulfur compounds and the nitrogen compounds transfer into the aqueous alkaline solvent, and
   the aqueous alkaline solvent is freed in a desorption column from the sulfur compounds and the nitrogen compounds in such a manner that a purified alkaline solvent is obtained which is passed back into the gas scrubber, and
   the desorbed gas, which contains the sulfur compounds and the nitrogen compounds, is passed into a Claus furnace in which they are partially burnt with an oxygen-containing gas, and is then passed into a Claus reactor for generating elemental sulfur, and
   the Claus residual gas obtained after passage through the Claus reactor is hydrogenated in such a manner that the remaining sulfur compounds are hydrogenated to hydrogen sulfide and the hydrogenated Claus residual gases are passed into an absorption column with an aqueous alkaline solvent, and
   the sulfur-containing and nitrogen-containing alkaline solvent obtained from the absorption column for the hydrogenated Claus residual gas is passed into the desorption column for the aqueous alkaline solvent from the first gas scrubber in such a manner that a shared desorption column is used for the gas scrubber for the sulfur-containing and nitrogen-containing acid gas and the absorption column for the hydrogenated Claus residual gas.

### BRIEF DESCRIPTION OF THE DRAWINGS

FIG. 1 is a flow chart illustrating the system according to the invention.

### DETAILED DESCRIPTION

In one embodiment of the invention, as aqueous, alkaline solvent, an aqueous sodium hydroxide solution is used. This aqueous sodium hydroxide solution can be ammoniacal, as is specified in U.S. Pat. No. 4,481,172A or in GB 1467083A. The aqueous sodium hydroxide solution can also contain a solubilizer, as is specified, for example, in EP0216486B1. In a further embodiment of the invention, the absorbent aqueous alkaline solvent contains an amine-containing solvent. In a further embodiment of the invention, the aqueous alkaline solvent contains methyldiethanolamine. In a further embodiment of the invention, the aqueous alkaline solvent is an aqueous ammoniacal solution. In each case, it is necessary to use an alkaline aqueous absorbent as solvent for the gas scrubber, in order to achieve sufficient absorption capacity not only for the non-oxidic sulfur and nitrogen compounds, but also for the sulfur dioxide.

In a further embodiment of the invention, the desorbed solvent from the gas scrubber or the sulfur-containing and nitrogen-containing gas from the desorption column or both, before being fed into the Claus furnace, are conducted through a cooler. As a result, the desorbed gas is freed from condensable components, and the Claus process is correspondingly relieved. The cooler in this case is configured as a heat exchanger. The cooler in this case is operated in an advantageous embodiment with a substream of the loaded solvent from the gas scrubber, which is withdrawn from the absorption column for the gas scrubber, and is conducted into the cooler for cooling the desorbed acid gas from the desorption column.

In a further embodiment of the method according to the invention, a substream of the desorbed solvent from the desorption column is recirculated to the absorption column for the hydrogenated Claus residual gas. It is also possible within the scope of the invention to recirculate further substreams of the desorbed solvent from the desorption column to the absorption column for the gas scrubber of the industrial gas. In this case, a further stripping step which is operated, for example, with hot steam for better desorption, can also be made use of.

In a further embodiment of the invention, the condensed components from the cooler which are present in the aqueous alkaline solvent and the condensed aqueous alkaline solvent are recirculated to the absorption column for the hydrogenated Claus residual gas. As a result, the non-combustible components of the desorbed gas are not conducted into the Claus process, and so the Claus process can be operated, depending on the heating value of the acid gas, without a foreign heating gas.

The Claus unit is generally operated in such a manner that it is run in a two-step manner, as is described in the reaction equations (1) and (2) discussed. However, at a lower utilization of the system, it is also possible to generate sulfur by stoichiometric combustion according to the reaction equation

2H₂S+O₂→2H₂O+¼S₈ (3).

In one embodiment of the invention, the Claus furnace is operated intermittently with all of the sulfur-containing gas and a substoichiometric amount of oxygen in such a manner that elemental sulfur is obtained directly in the Claus furnace. This sulfur is ejected from the process.

In a further embodiment of the invention, the desorbed gas obtained from the absorption column for the hydrogenated Claus residual gas is at least intermittently fed to a combustion. The desorbed gas which is withdrawn from the absorption column for the hydrogenated Claus residual gas can also be conducted into the Claus unit. There, the nitrogen compounds, however, are not completely converted into nitrogen, but, depending on the heating value of the gas that is to be burnt are not reacted or converted to nitrogen oxides. In order to eject the nitrogen compounds completely from the process, therefore, the desorbed gas from the absorption column can also be intermittently be fed to a suitable combustion furnace.

In a further embodiment, the desorbed gas obtained from the absorption column for the hydrogenated Claus residual gas is fed at least intermittently to the Claus furnace. As a result, there is a possibility to control the combustion of the Claus furnace with a preheated gas and to feed the remaining combustible compounds in the Claus residual gas to a complete combustion.

A system configuration is also claimed with which this process can be carried out, and which is characterized by the use of only one desorption column for the gas scrubbing process for the industrial gas and for the hydrogenated Claus residual gas. The method according to the invention and the associated system can additionally contain, at each point of the process flow, measuring installations, control installations, monitoring installations, valves, pumps or heating or cooling devices which are familiar to those skilled in the art for operating such processes.

The invention has the advantage, a gas scrubber by absorption with one absorbent solvent both of an industrial process and of a hydrogenated Claus residual gas in which nitrogen compounds are still present, wherein, for both processes, a single desorption column is utilized in such a manner that for both processes one solvent can be to utilized, as a result of which standardization and unification of the gas scrubbing process can be achieved in one Claus system, which leads to considerable cost savings. Via the method according to the invention, the sulfur emissions and the nitrogen emissions into the atmosphere of a method using a Claus process can be kept low.

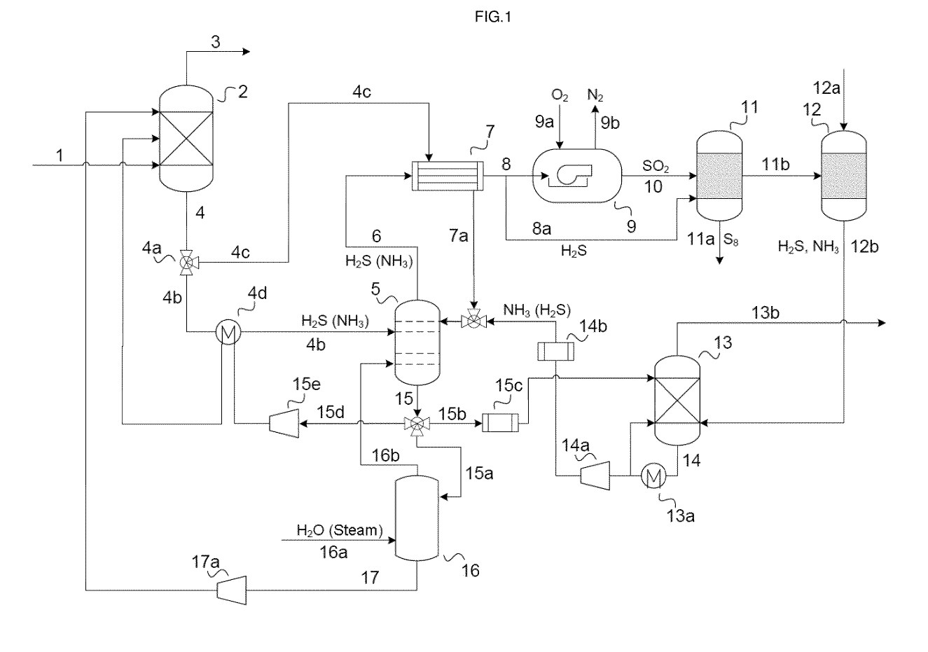

The invention will be described further with reference to FIG. 1, wherein this drawing shows only one exemplary embodiment and is not restricted thereto.

An industrial gas (1) that is to be purified is passed into a gas scrubbing column (2) for purification using an absorbent solvent. As a result, said industrial gas is freed from acid gas compounds in such a manner that a purified industrial gas (3) is obtained. The loaded solvent (4) is conducted into a desorption column (5). The loaded solvent (4) is divided into two streams (4b, 4c) by a distributor (4a), wherein the main stream (4b) is passed into the desorption column (5). In the desorption column (5), the loaded solvent (4) is desorbed in such a manner that the acid gases (6) are retained. These contain, in large part, depending on the industrial gas (1) presented, hydrogen sulfide (H₂S) and ammonia (NH₃). The acid gases (6) are conducted into a cooler (7) which cools the desorbed acid gas (6), by addition of the second substream (4c) of the loaded solvent (4) in such a manner that the condensable components (7a) condense out. The dried acid gas (8) is conducted into a Claus combustion furnace (9), into which an oxygen-containing gas (9a) is fed. There, the sulfur compounds are oxidized to sulfur dioxide (10, SO₂) and the resultant sulfur dioxide is conducted into a Claus reactor (11). In the combustion of the nitrogen-containing residual gases in the desorbed acid gas (6), nitrogen (9b) is produced. A substream (8a) of the dried acid gas (8) is branched off upstream of the Claus furnace (9) in the gas flow, and is likewise conducted into the Claus reactor (11). In the Claus reactor, the hydrogen sulfide reacts over a catalyst with the sulfur dioxide (10) to form elemental sulfur (11a, S₈), which is taken off. The desulfurized Claus residual gas (11b) is conducted into a hydrogenation reactor (12). There, the remaining sulfur compounds and nitrogen compounds are hydrogenated in such a manner that they are present as hydrogen sulfide (H₂S) and ammonia (NH₃). These are passed into an absorption column (13) for the hydrogenated Claus residual gas (12b). This is cooled by a cooler (13a). In this process a purified and desulfurized off-gas (13b) is obtained which can be passed into a combustion. The loaded solvent (14) is passed according to the invention, after passage through a further cooler (14b), into the same desorption column (5) as the loaded solvent (4) from the acid gas absorption (2) for the industrial gas (1). The desorbed solvent (15) from the desorption column (5) is divided, wherein a substream (15a) is passed into a stripping step to (16) which charges the desorbed solvent (15a) with a hot steam stream (16a) in such a manner that all the acid gases (16b) present therein are desorbed. The completely desorbed solvent (17) is recirculated to the absorption column (2) of the gas scrubber for the industrial gas (1). The acid gases (16b) that are stripped by the stream (16a) are recirculated to the desorption step (5). A further substream (15b) from the desorption step (5), after passage through a cooler (15c), is recirculated to the absorption column (13) for the hydrogenated Claus residual gas (12b), and the remaining stream (15d) of the desorbed solvent (15) is recirculated to the absorption column (2) for the industrial gas (1). The desorbed solvent heats up the loaded solvent in this process via a heat exchanger (4d). For the recirculation of the loaded or desorbed solvent streams (14, 15, 17), a pump (14a, 15e, 17a) is used for each.

### LIST OF REFERENCE SIGNS

1 Industrial gas

2 Gas scrubber

3 Purified industrial gas

4 Loaded solvent

4a Distributor

4b First substream of the loaded solvent

4c Second substream of the loaded solvent

4d Heat exchanger

5 Desorption column

6 Desorbed acid gas

7 Cooler

7a Condensate

8 Dried acid gas

8a Substream of the dried acid gas

9 Claus furnace

9a Oxygen or oxygen-containing gas

9b Nitrogen

10 Sulfur dioxide

11 Claus reactor

11a Elemental sulfur

11b Claus residual gas

12 Hydrogenation reactor

12a Hydrogen

12b Hydrogenated Claus residual gas

13 Absorption column

13a Cooler

13b Desulfurized off-gas

14 Loaded solvent

14a Pump

14b Cooler

15 Desorbed solvent

15a First substream of the desorbed solvent

15b Second substream of the desorbed solvent

15c Cooler

15d Third substream of the desorbed solvent

15e Pump

16 Stripping step

16a Steam

16b Completely desorbed acid gas

17 Completely purified solvent

17a Pump

1.-12. (canceled)

13. A method for scrubbing sulfur-containing gases with a circulated aqueous alkaline solvent, comprising the steps:
(1) scrubbing a sulfur-containing gas and nitrogen-containing acid gas in a gas scrubber with an aqueous alkaline solvent in such a manner that the sulfur compounds and the nitrogen compounds transfer into the aqueous alkaline solvent;
(2) freeing the aqueous alkaline solvent from the sulfur compounds and the nitrogen compounds in a desorption column in such a manner that a purified alkaline solvent is obtained;
(3) passing the purified alkaline solvent back into the gas scrubber;
(4) passing the desorbed gas containing the sulfur compounds and the nitrogen compounds into a Claus furnace in which they are partially burnt with an oxygen-containing gas;
(5) passing the desorbed gas into a Claus reactor to generate elemental sulfur; and
(6) hydrogenating the Claus residual gas obtained after passing though the Claus reactor in such a manner that the remaining sulfur compounds are hydrogenated to hydrogen sulfide; and
(7) passing the hydrogenated Claus residual gases into an absorption column with an aqueous alkaline solvent.

14. The method of claim 13, wherein the aqueous alkaline solvent is an aqueous solution of sodium hydroxide.

15. The method of claim 13, wherein the aqueous alkaline solvent contains an amine-containing solvent.

16. The method of claim 15, wherein the aqueous alkaline solvent contains methyldiethanol-amine.

17. The method of claim 13, wherein the aqueous alkaline solvent is an aqueous ammoniacal solution.

18. The method of claim 13, wherein the desorbed acid gas from the desorption column in step (2) is passed through heat exchanger to cool the desorbed gas before it is fed to the Claus furnace at step (4).

19. The method of claim 18, wherein a substream of the loaded solvent from the gas scrubber in step (1) is passed through the heat exchanger for cooling the desorbed acid gas from the desorption column in step (2).

20. The method of claim 18, wherein a substream of the desorbed solvent in step (2) is recirculated to the absorption column in step (7) for the hydrogenated Claus residual gas.

21. The method of claim 13, wherein the Claus furnace is operated intermittently with all of the sulfur-containing gas and a substoichiometric amount of oxygen in such a manner that elemental sulfur (S₈) is directly obtained in the Claus furnace.

22. The method of claim 13, wherein the desorbed gas obtained from the absorption column in step (7) for the hydrogenated Claus residual gas is fed at least intermittently to a combustion.

23. The method of claim 13, wherein the desorbed gas obtained from the absorption column in step (7) for the hydrogenated Claus residual gas is recirculated at least intermittently to the Claus furnace at step (4).

24. The method of claim 13, wherein the sulfur-containing and nitrogen-containing alkaline solvent obtained from the absorption column in step (7) is passed into the desorption column for the aqueous alkaline solvent from the first gas scrubber at step (1) in such a manner that a shared desorption column is used for the gas scrubber at step (1) and the absorption column at step (7).
